(19) United States
(12) Patent Application Publication
(10) Pub. No.: US 2025/0076177 A1
(43) Pub. Date: Mar. 6, 2025

(54) ALGORITHMS FOR FLOW CYTOMETRY COMPENSATION WITHOUT REQUIRING COMPENSATION CONTROLS

(71) Applicant: Georgia Tech Research Corporation, Atlanta, GA (US)

(72) Inventor: Peng Qiu, Atlanta, GA (US)

(21) Appl. No.: 18/824,482

(22) Filed: Sep. 4, 2024

Related U.S. Application Data
(60) Provisional application No. 63/536,591, filed on Sep. 5, 2023.

(51) Int. Cl. G01N 15/1434; G01N 15/01; G01N 15/10; G01N 15/1429

(52) U.S. Cl. CPC G01N 15/1434; G01N 15/01; G01N 15/1429; G01N 2015/1006

(57) ABSTRACT

An exemplary embodiment of the present disclosure provides a method of classifying a plurality of cells, comprising: providing a sample comprising a plurality of cells, the plurality of cells comprising a plurality of cell types; performing a flow cytometry process on the plurality of cells to generate an observation matrix; generating a compensation matrix based on the observation matrix; modifying the observation matrix with the compensation matrix to generate a compensated observation matrix; and classifying each of the plurality of cells into a cell type based on the compensated observation matrix.

### CROSS-REFERENCE TO RELATED APPLICATIONS

This application claims the benefit of U.S. Provisional Application Ser. No. 63/536,591, filed on 5 Sep. 2023, which is incorporated herein by reference in its entirety as if fully set forth below.

### FIELD OF THE DISCLOSURE

The various embodiments of the present disclosure relate generally to flow cytometry.

### BACKGROUND

Multi-color (or polychromatic) flow cytometry is a powerful technology for complex cellular analysis. With fluorescently-labeled antibodies to detect and quantify specific protein markers, flow cytometry is able to simultaneously measure up to 20 proteins for individual cells. This technology is crucial in identifying functionally homogeneous subsets of cells within the enormously complex immune system and also contributes to the deeper understanding of immunological diseases.

When multiple fluorescence channels are used in flow cytometry, detection problems may arise due to interference among different fluorescence channels. In general, the emission spectra of the fluorescent dyes are inherently wide and overlapping. Thus, the signal of a fluorescent dye may spillover into a channel applied for the detection of another fluorescent dye, causing interference across different channels. The simplest example to illustrate the spectral overlap is a two-color case with two dyes, fluorescein isothiocyanate (FITC) and Rphycoerythrin (R-PE). Both dyes are excited by a 488-nm laser, and the emitted photons are detected by photomultiplier tubes equipped with a 530/30-nm bandpass filter for FITC and a 585/42-nm bandpass filter for PE. As shown in FIG. 1, FITC can be detected in a first channel (FITC channel); however, about 15% of the emitted photons spillover into the second channel (R-PE channel) of the flow cytometer. On the other hand, about 2% of the photons emitted by R-PE are detected in the first channel (FITC channel).

The consequence of spectral spillover can be illustrated using the following simulation. Assume a model experiment where two cell surface antigens were stained with FITC and R-PE conjugated antibodies. Assume 25% of the cells were negative for both antigens, 25% were double positive, and 25-25% were positive for only one of the antigens. In an ideal case without any spillover, the four cell populations can be easily identified as shown in FIG. 2A. However, the reality with spillover is shown in FIG. 2B. Because of the significant spillover of FITC fluorescence into the R-PE channel, the FITC single-positive cells exhibit a relatively high fluorescence intensity in the R-PE channel. Consequently, the double-positive and FITC-positive cell populations colocalize in FIG. 2B, and the two populations cannot be discriminated.

Mathematically, the effect of spillover in flow cytometry can be represented by the following equation:

$$[ \begin{matrix}P {E}_{o b s} \\ {FITC}_{o b s}\end{matrix} ] = [ \begin{matrix}1 & 0.15 \\ 0.02 & 1\end{matrix} ] [ \begin{matrix}P {E}_{true} \\ {FITC}_{true}\end{matrix} ]$$

where the observed signal is a product of the spillover matrix and the true signal without spillover. Therefore, the effect of spillover can be removed by multiplying the inverse of the spillover matrix and the observed data. In flow cytometry analysis, the process of correcting the spillover effect is called compensation. The key challenge for performing compensation is how to obtain the spillover matrix.

In practice, the spillover matrix (also referred to herein as the compensation matrix) can be experimentally determined using compensation control samples, prepared for each fluorescence channel separately. FIGS. 3A-B show a compensation control sample stained for only FITC. FIG. 3A shows the unrealistic ideal case without spillover, where the R-PE signal is always low because the control sample is not stained for R-PE. FIG. 3B shows the reality with spillover, where observed R-PE is high for cells with high FITC. Based on the FITC-positive cells in the control sample, one can compute the spillover coefficient from FITC to R-PE (and from FITC to other channels if more than two channels are used).

Although the root of spillover is spectral overlap which only depends on the fluorescent dyes, the spillover coefficients among the same set of fluorescent dyes can vary across different studies, because they are affected by several factors including instrumentation differences (optics, filters, detectors, laser config), panel design (choice of fluorescent dye-antibody combinations), sample variability (autofluorescence, brightness, staining efficiency). As a result, researchers typically perform compensation control experiments for each study, and rarely re-use estimated spillover coefficients from previous studies.

In a flow cytometry staining panel involving multiple fluorescence channels, one compensation control sample is typically needed for each channel. An ideal compensation control would originate from the same sample, would contain adequate number of cells positive for the stained fluorescence channel, and the positive signal would be sufficiently bright. However, preparation of these controls can be cumbersome. In many applications, due to practical constraints, researchers have used alternative compensation controls based on cell lines, beads, and fluorescent dyes conjugated to different antibodies compared to the primary staining panel. As the number of measured channels increases, the issue of spillover and the difficulty of compensation both become more acute, as well as the amount of personnel and experimental costs for performing compensation. Even more problematic is that the compensation process typically must be reperformed regularly, particularly when any parameter changes (stains used, cell types, etc.). Thus, conventional techniques requiring many compensation sample collections makes flow cytometry even less efficient.

Accordingly, there is a need for improved systems and methods to address the spillover issues discussed above.

### BRIEF SUMMARY

An exemplary embodiment of the present disclosure provides a method of classifying a plurality of cells, comprising: providing a sample comprising a plurality of cells, the plurality of cells comprising a plurality of cell types; performing a flow cytometry process on the plurality of cells to generate an observation matrix; generating a compensation matrix based on the observation matrix; modifying the observation matrix with the compensation matrix to generate a compensated observation matrix; and classifying each of the plurality of cells into a cell type based on the compensated observation matrix.

In any of the embodiments disclosed herein, wherein the flow cytometry process comprises: staining the plurality of cells with a plurality of stains; stimulating the plurality of cells with energy to cause the stained cells to fluoresce; and measuring an intensity of the fluorescence from the plurality of cells.

In any of the embodiments disclosed herein, measuring an intensity of the fluorescence from the plurality of cells can comprise measuring an intensity of the fluorescence from the plurality of cells with a plurality of detectors, wherein each detector can be configured to detect a bandwidth of light corresponding to a distinct stain in the plurality of stains.

In any of the embodiments disclosed herein, the observation matrix can comprise, for each of the plurality of cells, an intensity measurement for each of the plurality of detectors.

In any of the embodiments disclosed herein, generating the compensation matrix can comprise performing two or more iterations of a compensation process. The compensation process can comprise: performing a clustering algorithm on the observation matrix to generate a clustered observation matrix; generating an updated compensation matrix based on the clustered observation matrix; and modifying the clustered observation matrix based on the updated compensation matrix.

In any of the embodiments disclosed herein, the compensation matrix can comprise a plurality of compensation coefficients.

In any of the embodiments disclosed herein, the compensation process can terminate when consecutive iterations of the compensation process generate updated compensation matrices having corresponding compensation coefficients that differ less than a predetermined threshold.

In any of the embodiments disclosed herein, the clustering algorithm can comprise: performing an inverse hyperbolic sine transformation (arcsinh) to transform data in the observation matrix to log space; constructing a shared nearest neighbor (SNN) graph using Euclidean distance metric; and using a Louvain community finding algorithm to cluster cells in the observation matrix into a plurality of cell clusters.

In any of the embodiments disclosed herein, generating an updated compensation matrix can comprise, for each cell cluster: computing pairwise correlations among a plurality of channels to form a correlation matrix, each channel corresponding to intensity measurements by a corresponding detector in the plurality of detectors; summing the correlation matrices across all cell clusters to obtain an overall correlation matrix; determining whether convergence is achieved by summing off-diagonal elements in the overall correlation matrix; ranking channel pairs from most to least affected by spillover; and selecting a top ranked channel pair as the first subset of channels.

In any of the embodiments disclosed herein, ranking channel pairs from most to least affected by spillover can comprise rank ordering all off-diagonal elements in the overall correlation matrix in descending order.

In any of the embodiments disclosed herein, generating an updated compensation matrix can further comprise: Step 1—performing a regression analysis on the observation matrix to predict a first channel if the first subset of channels based on a second channel in the first subset of channels to obtain a first compensation coefficient candidate; Step 2—use the first compensation coefficient candidate to correct the first channel based on the second channel for all cells in a cluster; Step 3—re-computing a correlation between the first and second channels for each cluster after correction to determine whether correlation is reduced; performing steps 1, 2, and 3 for each cell cluster to find a spillover coefficient from the second channel to the first channel that leads to a reduction of correlation; and performing steps 1, 2, and 3 for each cell cluster to find a spillover coefficient from the first channel to the second channel that leads to a reduction of correlation.

In any of the embodiments disclosed herein, the method can further comprise outputting the updated compensated observation matrix.

Another embodiment of the present disclosure provides a system for classifying a plurality of cells, comprising a fluidic channel, an energizer, a plurality of detectors, at least one processor, and at least one memory. The fluidic channel can be configured to flow a sample comprising a plurality of cells. The plurality of cells can comprise a plurality of cell types. The energizer can be configured to energize the plurality of cells to cause the plurality of cells to fluoresce light. Each detector can be configured to measure an intensity of light in a predetermined bandwidth fluoresced by each of the plurality of energized cells. The memory can comprise instructions that, when executed by the at least one processor, cause the at least one processor to: generate an observation matrix comprising the intensity measurements by each of the plurality of detectors for each of the plurality of cells; generate a compensation matrix based on the observation matrix, the compensation matrix comprising a compensation coefficient for each of the plurality of detectors; modify the observation matrix with the compensation matrix to generate a compensated observation matrix; and classify each of the plurality of cells into a cell type based on the compensated observation matrix.

In any of the embodiments disclosed herein, the plurality of cells can be stained with a plurality of stains.

In any of the embodiments disclosed herein, the at least one memory can further comprise instructions that, when executed by the at least one processor, cause the at least one processor to generate the compensation matrix, at least in part, by performing two or more iterations of a compensation process. The compensation process can comprise: performing a clustering algorithm on the observation matrix to generate a clustered observation matrix; generating an updated compensation matrix based on the clustered observation matrix; and modifying the clustered observation matrix based on the updated compensation matrix.

In any of the embodiments disclosed herein, the at least one memory can further comprise instructions that, when executed by the at least one processor, cause the at least one processor to terminate the compensation process when consecutive iterations of the compensation process generate updated compensation matrices having corresponding compensation coefficients that differ less than a predetermined threshold.

In any of the embodiments disclosed herein, the clustering algorithm can comprise: performing an inverse hyperbolic sine transformation (arcsinh) to transform data in the observation matrix to log space; constructing a shared nearest neighbor (SNN) graph using Euclidean distance metric; and using a Louvain community finding algorithm to cluster cells in the observation matrix into a plurality of cell clusters.

In any of the embodiments disclosed herein, the at least one memory can further comprise instructions that, when executed by the at least one processor, cause the at least one processor to generate an updated compensation matrix, at least in part, by: for each cell cluster, computing pairwise correlations among a plurality of channels to form a correlation matrix, each channel corresponding to intensity measurements by a corresponding detector in the plurality of detectors; summing the correlation matrices across all cell clusters to obtain an overall correlation matrix; determining whether convergence is achieved by summing off-diagonal elements in the overall correlation matrix; ranking channel pairs from most to least affected by spillover; and selecting a top ranked channel pair as the first subset of channels.

In any of the embodiments disclosed herein, ranking channel pairs from most to least affected by spillover can comprise rank ordering all off-diagonal elements in the overall correlation matrix in descending order.

In any of the embodiments disclosed herein, the at least one memory can further comprise instructions that, when executed by the at least one processor, cause the at least one processor to generate an updated compensation matrix by, at least in part: Step 1—performing a regression analysis on the observation matrix to predict a first channel if the first subset of channels based on a second channel in the first subset of channels to obtain a first compensation coefficient candidate; Step 2—use the first compensation coefficient candidate to correct the first channel based on the second channel for all cells in a cluster; Step 3—re-computing a correlation between the first and second channels for each cluster after correction to determine whether correlation is reduced; performing steps 1, 2, and 3 for each cell cluster to find a spillover coefficient from the second channel to the first channel that leads to a reduction of correlation; and performing steps 1, 2, and 3 for each cell cluster to find a spillover coefficient from the first channel to the second channel that leads to a reduction of correlation.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 provides a plot of emission spectra of FITC and R-PE, in which the highlighted bands demonstrate the selected spectral ranges in the left (FITC) and right (R-PE) detectors and the cross-hatched area represents the spillover fluorescence.

FIGS. 2A-B provide plots of four cell types that can be distinguished by two markers stained by FITC and PE. FIG. 2A provides an unrealistic situation without spillover, in which the four cell types are separated. FIG. 2B provides a plot with real data, in which spillover induces spurious correlation, such that the FITC single positive cell types and the double positive cell type are no longer separated.

FIGS. 3A-B provide plots of an FITC-single-stain control sample. FIG. 3A provides an unrealistic ideal case without spillover, where the R-PE signal is always low because the control sample is not stained for R-PE. FIG. 3B provides a realistic plot with spillover, in which observed R-PE is high for cells with high FITC.

FIGS. 4A-C provides results of a simulation evaluation of an exemplary embodiments of the present disclosure, in which FIG. 4A provides simulated spillover coefficients, FIG. 4B illustrates convergence of cluster-specific correlation as the algorithm iterated, and FIG. 4C provides a scatter plot of true and predicted spillover coefficients.

FIG. 5 provides a plot showing the spillover determined via conventional compensation controls (ground truth) and the spillover estimated by an exemplary embodiment of the present disclosure.

FIG. 6 provides a system for classifying a plurality of cells, in accordance with some embodiments of the present disclosure.

FIG. 7 provides a block diagram of a computing device that that can be utilized with some embodiments of the present disclosure.

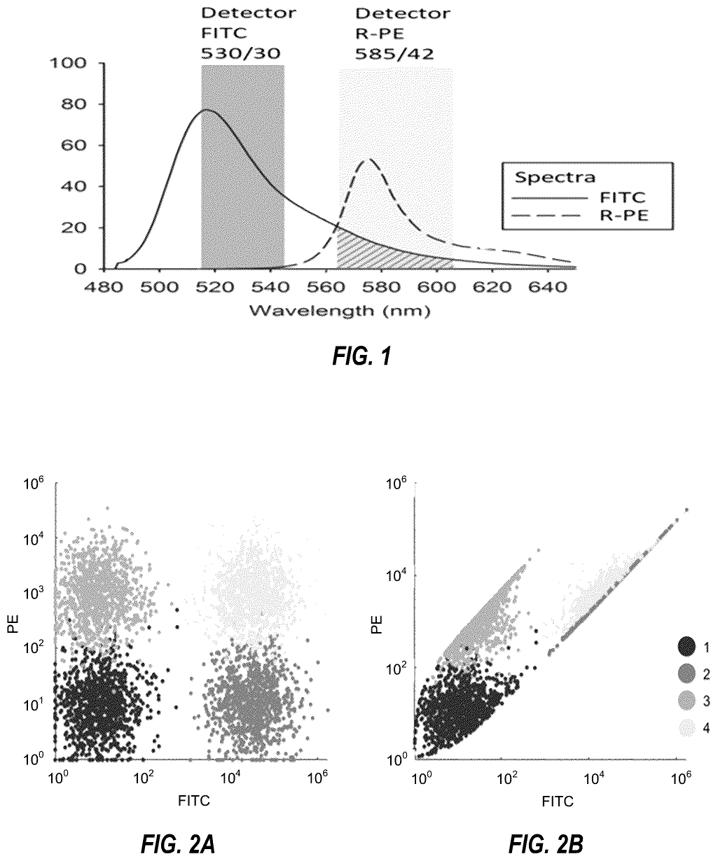

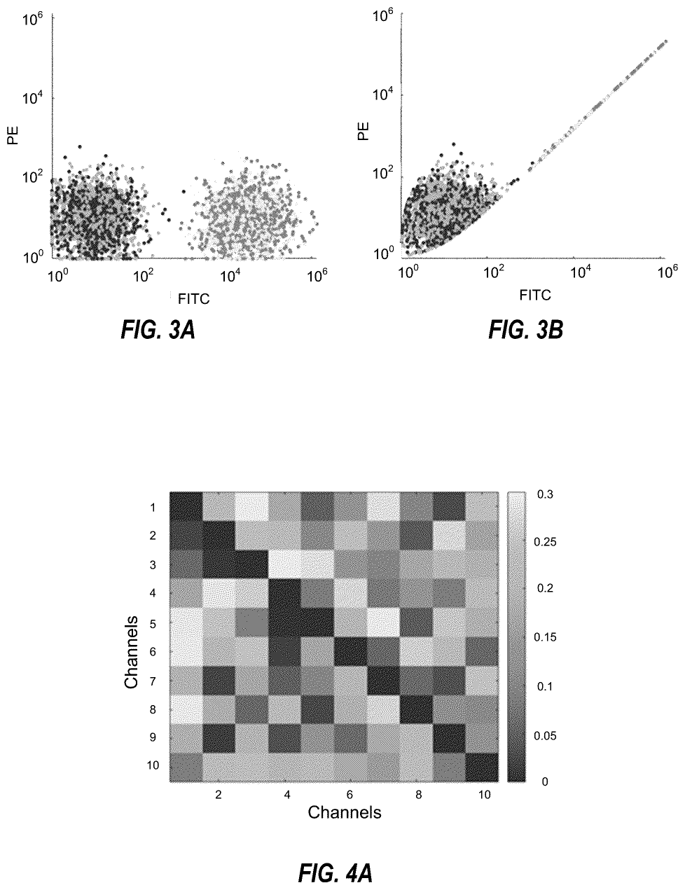

### DETAILED DESCRIPTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used in the specification and the appended claims, the singular forms “a,” “an” and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges can be expressed herein as from “about” or “approximately” one particular value and/or to “about” or “approximately” another particular value. When such a range is expressed, another exemplary embodiment includes from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Reference will now be made in detail to exemplary embodiments of the disclosed technology, examples of which are illustrated in the accompanying drawings and disclosed herein. Wherever convenient, the same references numbers will be used throughout the drawings to refer to the same or like parts.

The present disclosure presents novel computational techniques and presents systems and methods for estimating the spillover coefficients without requiring compensation controls. Given the prevalence of flow cytometry in biological and biomedical research, embodiments disclosed herein provide huge savings in terms of both experimental and personnel costs, which will be a significant impact to the research community.

Although flow cytometry has been widely used for almost 50 years, the practice of experimentally estimating spillover from compensation controls has not changed since it was introduced by Shapiro and Herzenberg back in the 1970's. In the literature, there is only one existing algorithm for estimating spillover without controls, which was named CytoSpill, and was published in 2021. CytoSpill was designed to estimate the spillover matrix for CyTOF data. The algorithm included statistical modeling of biomodality to identify informative channels, sequential quadratic programming to estimate spillover coefficients, followed by non-negative matrix factorization to perform compensation. CytoSpill's key assumption was “spillover noise contributes as a new modal at the lower end of the affected channel expression density.” With the biomodality inference to separate the noise modal from the signal modal, CytoSpill was able to accurately estimate the spillover coefficients for CyTOF data. The key advantage of CyTOF compared to flow cytometry is that CyTOF uses heavy metal isotopes to label antibodies, and the heavy metal isotopes have minimal spectral overlap. As a result, the problem of spillover estimation in CyTOF is less challenging than that in flow cytometry. The authors of CytoSpill explicitly stated that their algorithm was not applicable to flow cytometry. Therefore, the problem of estimating spillover in flow cytometry without controls is completely unsolved.

In flow cytometry analysis, compensation is part of data preprocessing and quality control, whereas the subsequent question of cell type identification is performed as a separate analysis via manual gating or automated clustering algorithms. In this project, the key computational innovation is to jointly consider compensation and cell type identification. When iterating between the two, identified cell types allows estimation of elements in the spillover matrix, and compensation based on the estimated spillover improves data quality to better identify cell types. This disclosure presents the first approach that jointly considers compensation and cell type identification in flow cytometry analysis.

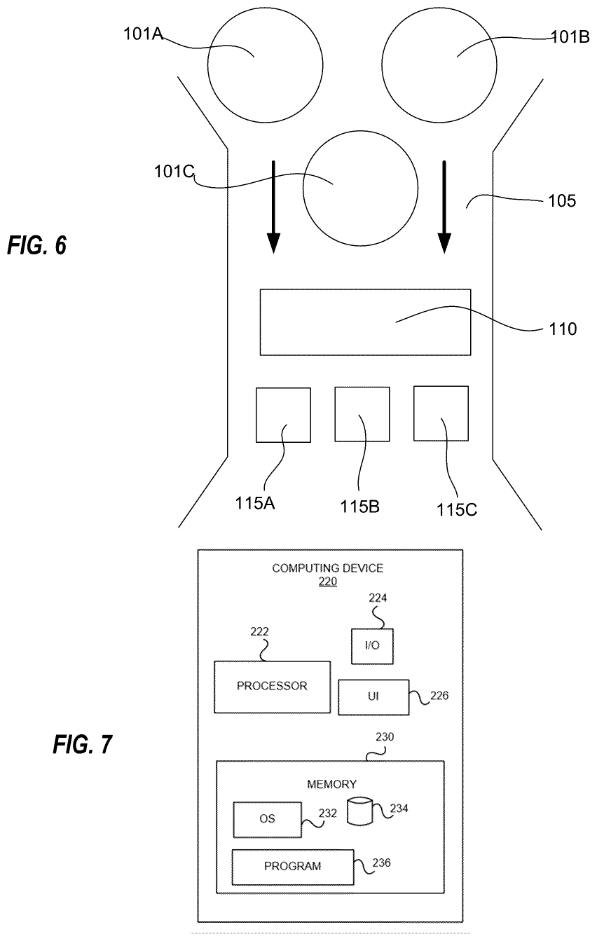

In particular, embodiments of the present disclosure can allow for estimating spillover coefficients to preprocess measured data to more accurately classify cells in a sample. For example, an exemplary embodiment of the present disclosure provides a method of classifying a plurality of cells. The method can comprise providing a sample comprising a plurality of cells to be classified. The plurality of cells can comprise cells with many different cell types. The classification can then accurately classify the various cells into the various cell types. Flow cytometry can be performed on the plurality of cells. An exemplary block diagram of a system for performing the flow cytometry is shown in FIG. 6. A plurality of cells 101A-C can be stained with a plurality of stains. Each stain can be configured to interact with a particular protein associated with certain of the cells. For example, cell 101A may have proteins that interact with stains A and B, cell 101B may have proteins that interact with stains B and C, and cell 101C may have proteins that interact with stain D. The cells 101A-C can flow through a channel 105. The cells 101A-C can pass by an energizer 110 which can apply energy in the direction of the cells. The energizer 110 can be many different energizers known in the art. In some embodiments, the energizer 110 can be a laser configured to emit light in the direction of the cells. The energy can cause stains on the cell to fluoresce. Each stain can fluoresce a particular bandwidth of light. The cells can then pass by a plurality of detectors 115A-C configured to measure an intensity of the fluoresced light. Though only three detectors are shown in FIG. 6, the disclosure is not so limited. In some embodiments, the system can comprise a detector for each distinct stain employed. Each detector can be configured to detect a particular bandwidth of light corresponding to each stain. The measurement of the intensity of each bandwidth of light from each detector can be stored in an observation matrix. Using the observation matrix (without independent measurement taken using only a single or portion of the detectors), embodiments of the present disclosure can generate a compensation matrix. The compensation matrix can comprise a plurality of compensation/spillover coefficients. The observation matrix can then be modified using the compensation matrix to create an updated/compensated observation matrix that accounts for the spillover between detectors. The compensated observation matrix can then be utilized to classify cells into a cell type.

Potential algorithms that can be used to generate the compensation matrix are disclosed in detail below. Some embodiments, utilize an iterative process employing a clustering algorithm to generate a compensation matrix. For example, in some embodiments, the process can include multiple iterations of: performing a clustering algorithm on the observation matrix to generate a clustered observation matrix; generating an updated compensation matrix based on the clustered observation matrix; and modifying the clustered observation matrix based on the updated compensation matrix (the next iteration can then proceed with performing a clustering algorithm on the updated compensation matrix). The iterative process can continue until the coefficients in the compensation matrix converge to certain values (e.g., consecutive iterations yield differences in the spillover coefficients less than a predetermined threshold.

Details of certain embodiments are discussed below.

### Exemplary Computational Technology

A Novel Framework for Estimating Spillover in Flow Cytometry without Compensation Controls;

FIG. 2 shows a simulated dataset with two fluorescence channels (FITC and R-PE), containing a total of 4 distinct cell populations. As described earlier, FIG. 2A represents an ideal case without spillover, while FIG. 2B represents a realistic case with significant spillover from FITC to R-PE and moderate spillover from R-PE to FITC. One key observation is that spillover induced correlations between fluorescence channels, and such correlations can be very strong within certain cell clusters. Assuming it is known how cells are clustered (this assumption is unrealistic), regression analysis of the two fluorescence channels can be performed against each other for each cell cluster separately, and the following can be observed:
1) Using cells in cluster 2, linear regression can accurately estimate the spillover coefficient from FITC to R-PE. This is because cells in cluster 2 highly expressed the protein corresponding to FITC and lowly expressed the protein corresponding to R-PE (as shown in the ideal case in FIG. 2A without spillover), thus, the observed R-PE signal in cluster 2 is primarily contributed by spillover from FITC.
2) Using cells in cluster 3, linear regression can accurately estimate the spillover coefficient from R-PE to FITC, and the reasoning is the same as above.
3) If clusters 1, 3, 4 are tried to be used to estimate spillover from FITC to R-PE, or cluster 1, 2, 4 are tried to be used to estimate the spillover from R-PE to FITC, the estimation accuracy is poor.

These observations indicate that certain subsets of cells were more useful for estimating the spillover between certain pairs of channels. This is a motivation of the proposed computational framework disclosed herein, namely to jointly consider cell clustering and spillover estimation to reduce cluster-specific correlations among channels.

### Mathematical Formulation for Spillover Estimation:

We use Y to denote the observed flow cytometry data matrix, where each row represents a cell and each column represents a channel. We use X to denote the true signal of single-cell protein expression, which can be the ideal data without spillover. The dimensionality of X and Y can be the same. The observation Y and the true signal X can be related by the spillover matrix S, which can be a square matrix and its size can be the same as number of channels. Their relationship can be written as the following linear equation Y=X S. We can further use cᵢ (i=1, 2, . . . , n) to denote a clustering result of the cells based on X. With these notions, we can formulate the spillover estimation problem as the following optimization problem:

$$S = {arg min}_{s} {\sum }_{k = 1}^{K} {C}_{k}$$

where Cₖ can be the average correlation among channels, computed based on cells in cluster k. Since X can be unobserved, we can compute the cluster assignment by applying community finding algorithm to S⁻¹Y, which can lead to an iterative approach for solving this optimization problem: we can initialize S as the identity matrix, cluster the cells based on S⁻¹Y, use the above optimization formulation to update S, and then iterate back to re-cluster the cells based on the updated S⁻¹Y and re-visit the optimization formulation to further update S. When this iterative process converges, we can arrive at a good estimation of the spillover matrix.
An Algorithm for Estimating Spillover in Flow Cytometry without Compensation Controls:

Disclosed herein is also an algorithm for estimating spillover coefficients without compensation controls. A key idea is to perform cell clustering, spillover estimation, compensation, and then re-do clustering and iterate until convergence. Since spillover can induce cluster-specific correlation among fluorescence channels, cluster-specific correlations can be used to monitor the progress and convergence of the algorithm. An exemplary algorithm is disclosed below:
1. Take the raw uncompensated data or corrected data from step 4b:
   a. perform inverse hyperbolic sine transformation (arcsinh) to transform data to log space,
   b. construct a shared nearest neighbor (SNN) graph using Euclidean distance metric
   c. use Louvain community finding algorithm to cluster cells, assuming K clusters are obtained
2. Identify the pair of channels to estimate spillover
   a. For each cell cluster, compute pairwise correlations among the channels
   b. Sum the correlation matrices across all cell clusters to obtain an overall correlation matrix
   c. Use the sum of all off-diagonal elements to monitor the progress of the iterative algorithm, stop the iteration if convergence is observed.
   d. Rank order all off-diagonal elements in descending order, which leads to ranked channel pairs from most to least affected by spillover
   e. In the ranked list and find the first i, j channel pair not in the to-avoid list (see step 4a)
3. Estimate the spillover coefficients between the i, j channels identified in step 2e.
   a. Focus on one cell cluster, use cells in the cluster as data points, use data in the original linear space, perform regression analysis to predict channel i based on channel j, and the resulting coefficient is a candidate for Sⱼᵢ (spillover coefficient from channel j to channel i)
   b. Use this candidate spillover coefficient to correct channel i based on channel j, for all cells in all clusters. Re-compute the correlation between channels i, j for each cluster after this correction. Examine whether the correlation reduces after the correction.
   c. Do sub-steps 3a-3b for each cell cluster, and find the best Sⱼᵢ spillover coefficient from channel j to channel i that leads to the most reduction of correlation
   d. Do sub-steps 3a-3c to find the best Si spillover coefficient from channel i to channel j
4. Compensate channels i, j, or discard the estimated spillover coefficient
   a. If any of the following conditions are satisfied, we discard these estimated coefficients, do not change the data, remember i, j channel pair in the to-avoid list, and go back to step 2e.
      i. If Sᵢⱼ or Sⱼᵢ is negative or >1.5 (estimated spillover being negative or too large)
      ii. If the both Sᵢⱼ and Sⱼᵢ are very tiny (<1e-6),
   b. Otherwise, we compensate/correct data for channels i, j, remove pairs in the to-avoid list that involve either i or j, go back to step 1

At least two variations of the above algorithm have also been experimented with. First, instead of identifying a channel pair in step 2 which is pursued in steps 3 and 4, we tried exhaustively look at all possible channel pairs in steps 3 and 4, and picked the pair that led to largest amount of reduction in cluster specific correlations. Second, we also tried another variation for step 2, where we identified channel pairs by applying non-negative matrix factorization and singular value decomposition to the cluster-specific correlation matrices. These two variations both achieved similar performance in estimating the spillover matrix.

### Evaluation Results

### Evaluation Based on Simulated Data

We simulated flow cytometry data with complex spillover situation. In our simulation, the number of channels is 10, the number of cell types is 30, and the number of cells per cell type is 1000. Each cell type is positive for a random subset of the 10 channels, and negative for the rest (total number of possible cell types is 210). The simulated spillover-free fluorescence data followed log-normal distribution. If we only simulated 2 channels and 4 cell types, the simulated spillover-free data would look like FIG. 2A. The simulated spillover matrix is 10*10, where all diagonal elements were 1, and off-diagonal elements were randomly sampled from a uniform distribution between 0 and 0.3.

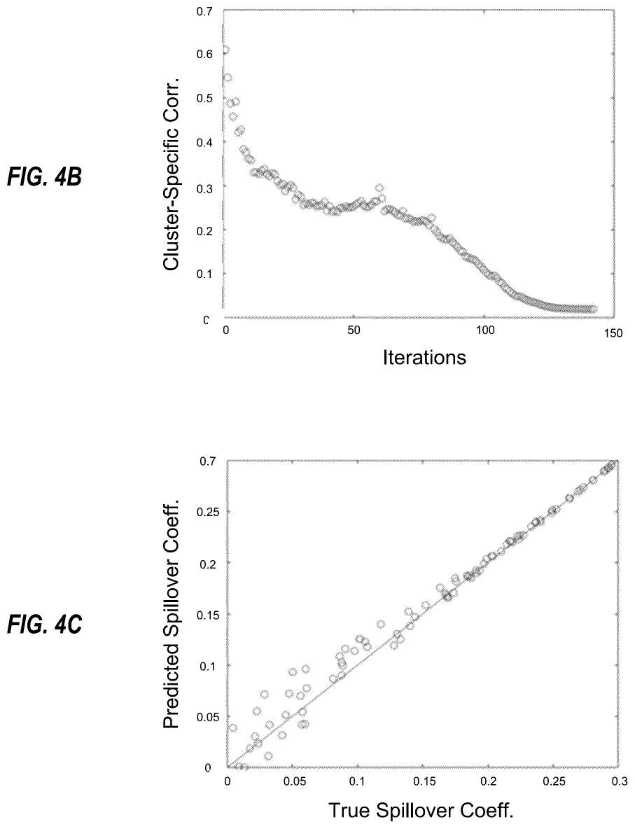

We generated 100 simulated datasets to test the algorithm. FIG. 4 showed one example. The simulated spillover matrix was shown in FIG. 4A. As the algorithm iterated, the overall correlation in step 2c was shown in FIG. 4B, which monitored the progress and convergence of the algorithm. Upon convergence, the estimated spillover coefficients closely tracked the simulation ground truth, as shown in FIG. 4C. Among the 100 simulated datasets, the algorithm achieved similar performance in 98 datasets, and failed to converge in the remaining 2 datasets. The simulation result demonstrated the feasibility of accurately estimating spillover without compensation controls.

When we simulated trivial scenarios, such as datasets with 10 channels but only 2 cell types, the algorithm did not converge. This was expected. Given the low heterogeneity in the simulated data (too few cell types), there was not enough information to allow estimation of the 10*10 spillover matrix. In fact, in real flow cytometry experiments, if a staining panel does not reveal heterogeneity in the cell population, the experimental design should be re-visited, and the staining panel would be re-designed.

### Evaluate the Algorithm on Real Flow Cytometry Data

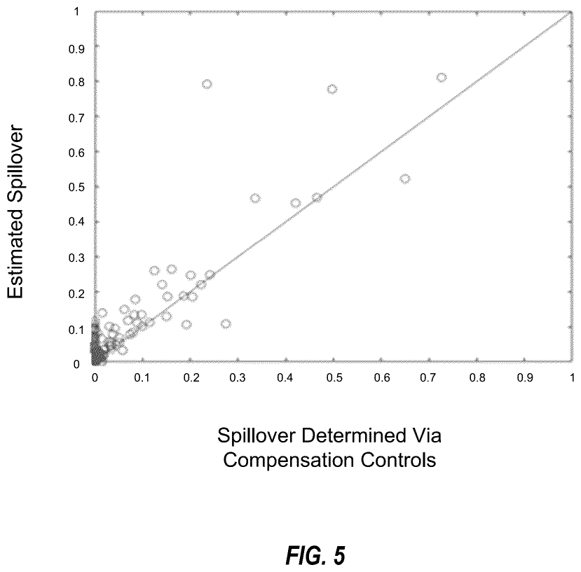

We evaluated the exemplary algorithm on several real flow cytometry datasets. One example dataset contained 15 channels and a total of 131,733 cells, acquired using the BD FACSymphony A5 system at the Flow Cytometry Core Facility at Emory University. When applied to this dataset, the exemplary algorithm went through 97 iterations. FIG. 5 compared the spillover determined via compensation controls (ground truth) and the spillover estimated by the exemplary algorithm. It was encouraging that the exemplary algorithm captured the large spillover effects, although it achieved lower accuracy on small spillover effects.

### Potential Algorithmic Improvements

The exemplary algorithms disclosed herein provides a framework for computational compensation without requiring compensation control samples. The algorithms work well on challenging simulation scenarios and showed promise in real flow cytometry data. Under this framework, there are several potential variations contemplated within the scope of the present disclosure:
1) In step 3 of the algorithm, each spillover coefficient is estimated based on one selected cell cluster. However, it is possible and often the case that multiple cell clusters can all be appropriate for estimating a particular spillover coefficient. Step 3 can be extended to consider this, which can improve estimation accuracy and reduce over-compensation.
2) In practice, one flow cytometry study often uses a common staining panel and a fixed instrument setting to analyze many biological samples. Therefore, the resulting datasets for different samples can share the same spillover matrix. The algorithm above takes one dataset/sample as input. This can be extended to jointly consider multiple samples and estimate their shared spillover matrix.
3) In step 4a of the algorithm above, the estimated spillover coefficients can be discarded if the estimated spillover is negative or too large. The threshold of 1.5 is a heuristic based on spillover coefficients observed in real flow cytometry datasets. The heuristic in step 4a can be updated using statistical modeling and hypothesis testing, which can help the algorithm avoid over-compensating the data.

All these potential algorithmic improvements fall within the same computational framework and idea, which is to jointly consider cell clustering and spillover estimation, and estimate spillover by minimizing cluster-specific correlation among channels.

### Expected Outcome and Impact

In the research communities that use flow cytometry, compensation is typically performed by experimentally profiling single-stain compensation control samples. The present disclosure presents a novel computational approach for compensating flow cytometry data without requiring single-stain compensation controls. Given the prevalence of flow cytometry in biological and biomedical research, this technology can lead to huge savings in terms of both experimental and personnel costs, which will be a significant impact to the research community.

In terms of the commercialization value, this technology should be of interest to manufactures of flow cytometry instruments and companies that develop flow cytometry data analysis software. If this technology is integrated into software for flow cytometry instruments or analysis, it will help users (researchers) to reduce time and costs in their flow cytometry experiments.

FIG. 7 illustrates an exemplary computing device that can be used to implement the methods/algorithms (or one or more steps of the methods/algorithms) disclosed herein. For example, the computing device shown in FIG. 7 can receive data from the plurality of detectors 115A-C in FIG. 6 and process the data in accordance with the various processes disclosed herein. As will be appreciated by one of skill in the art, the computing device 220 can be configured to implement all or some of the features described in relation to the methods 1000 1100. As shown, the computing device 220 may include a processor 222, an input/output (“I/O”) device 224, a memory 230 containing an operating system (“OS”) 232 and a program 236. In certain example implementations, the computing device 220 may be a single server or may be configured as a distributed computer system including multiple servers or computers that interoperate to perform one or more of the processes and functionalities associated with the disclosed embodiments. In some embodiments, computing device 220 may be one or more servers from a serverless or scaling server system. In some embodiments, the computing device 220 may further include a peripheral interface, a transceiver, a mobile network interface in communication with the processor 222, a bus configured to facilitate communication between the various components of the computing device 220, and a power source configured to power one or more components of the computing device 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 222 to communicate with other devices via wired or wireless networks, whether local or wide area, private or public, as known in the art. A power source may be configured to provide an appropriate alternating current (AC) or direct current (DC) to power components.

The processor 222 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 222 may be one or more known processing devices, such as, but not limited to, a microprocessor from the Pentium™ family manufactured by Intel™ or the Turion™ family manufactured by AMD™. The processor 222 may constitute a single core or multiple core processor that executes parallel processes simultaneously. For example, the processor 222 may be a single core processor that is configured with virtual processing technologies. In certain embodiments, the processor 222 may use logical processors to simultaneously execute and control multiple processes. The processor 222 may implement virtual machine technologies, or other similar known technologies to provide the ability to execute, control, run, manipulate, store, etc. multiple software processes, applications, programs, etc. The processor 222 may also comprise multiple processors, each of which is configured to implement one or more features/steps of the disclosed technology. One of ordinary skill in the art would understand that other types of processor arrangements could be implemented that provide for the capabilities disclosed herein.

In accordance with certain example implementations of the disclosed technology, the computing device 220 may include one or more storage devices configured to store information used by the processor 222 (or other components) to perform certain functions related to the disclosed embodiments. In one example, the computing device 220 may include the memory 230 that includes instructions to enable the processor 222 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the computing device 220 may include a memory 230 that includes instructions that, when executed by the processor 222, perform one or more processes consistent with the functionalities disclosed herein. Methods, systems, and articles of manufacture consistent with disclosed embodiments are not limited to separate programs or computers configured to perform dedicated tasks. For example, the computing device 220 may include the memory 230 that may include one or more programs 236 to perform one or more functions of the disclosed embodiments.

The processor 222 may execute one or more programs located remotely from the computing device 220. For example, the computing device 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 222, perform one or more processes consistent with the disclosed embodiments. In some examples, the memory 230 may include a database 234 configured to store various data described herein. For example, the database 234 can be configured to store the software repository 102 or data generated by the repository intent model 104 such as synopses of the computer instructions stored in the software repository 102, inputs received from a user (e.g., responses to questions or edits made to synopses), or other data that can be used to train the repository intent model 104.

The computing device 220 may also be communicatively connected to one or more memory devices (e.g., databases) locally or through a network. The remote memory devices may be configured to store information and may be accessed and/or managed by the computing device 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The computing device 220 may also include one or more I/O devices 224 that may comprise one or more user interfaces 226 for receiving signals or input from devices and providing signals or output to one or more devices that allow data to be received and/or transmitted by the computing device 220. For example, the computing device 220 may include interface components, which may provide interfaces to one or more input devices, such as one or more keyboards, mouse devices, touch screens, track pads, trackballs, scroll wheels, digital cameras, microphones, sensors, and the like, that enable the computing device 220 to receive data from a user.

In example embodiments of the disclosed technology, the computing device 220 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While the computing device 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the computing device 220 may include a greater or lesser number of components than those illustrated.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A method of classifying a plurality of cells, comprising:
providing a sample comprising a plurality of cells, the plurality of cells comprising a plurality of cell types;
performing a flow cytometry process on the plurality of cells to generate an observation matrix;
generating a compensation matrix based on the observation matrix;
modifying the observation matrix with the compensation matrix to generate a compensated observation matrix; and
classifying each of the plurality of cells into a cell type based on the compensated observation matrix.

2. The method of claim 1, wherein the flow cytometry process comprises:
staining the plurality of cells with a plurality of stains;
stimulating the plurality of stained cells with energy to cause the stained cells to fluoresce; and
measuring an intensity of the fluorescence from the plurality of stained cells.

3. The method of claim 2, wherein measuring an intensity of the fluorescence from the plurality of stained cells comprises measuring an intensity of the fluorescence from the plurality of cells with a plurality of detectors, each detector configured to detect a bandwidth of light corresponding to a distinct stain in the plurality of stains.

4. The method of claim 3, wherein the observation matrix comprises, for each of the plurality of stained cells, an intensity measurement for each of the plurality of detectors.

5. The method of claim 4, wherein generating the compensation matrix comprises performing two or more iterations of a compensation process, the compensation process comprising:
performing a clustering algorithm on the observation matrix to generate a clustered observation matrix;
generating an updated compensation matrix based on the clustered observation matrix; and
modifying the clustered observation matrix based on the updated compensation matrix.

6. The method of claim 5, wherein the compensation matrix comprises a plurality of compensation coefficients.

7. The method of claim 6, wherein the compensation process terminates when consecutive iterations of the compensation process generate updated compensation matrices having corresponding compensation coefficients that differ less than a predetermined threshold.

8. The method of claim 5, wherein the clustering algorithm comprises:
performing an inverse hyperbolic sine transformation (arcsinh) to transform data in the observation matrix to log space;
constructing a shared nearest neighbor (SNN) graph using Euclidean distance metric; and
using a Louvain community finding algorithm to cluster cells in the observation matrix into a plurality of cell clusters.

9. The method of claim 8, wherein generating an updated compensation matrix comprises:
for each cell cluster, computing pairwise correlations among a plurality of channels to form a correlation matrix, each channel corresponding to intensity measurements by a corresponding detector in the plurality of detectors;
summing the correlation matrices across all cell clusters to obtain an overall correlation matrix;
determining whether convergence is achieved by summing off-diagonal elements in the overall correlation matrix;
ranking channel pairs from most to least affected by spillover; and
selecting a top ranked channel pair as the first subset of channels.

10. The method of claim 9, wherein ranking channel pairs from most to least affected by spillover comprises rank ordering all off-diagonal elements in the overall correlation matrix in descending order.

11. The method of claim 9, wherein generating an updated compensation matrix further comprises:
Step 1—performing a regression analysis on the observation matrix to predict a first channel if the first subset of channels based on a second channel in the first subset of channels to obtain a first compensation coefficient candidate;
Step 2—use the first compensation coefficient candidate to correct the first channel based on the second channel for all cells in a cluster;
Step 3—re-computing a correlation between the first and second channels for each cluster after correction to determine whether correlation is reduced;
performing steps 1, 2, and 3 for each cell cluster to find a spillover coefficient from the second channel to the first channel that leads to a reduction of correlation; and
performing steps 1, 2, and 3 for each cell cluster to find a spillover coefficient from the first channel to the second channel that leads to a reduction of correlation.

12. The method of claim 1, further comprising outputting the updated compensated observation matrix.

13. A system for classifying a plurality of cells, comprising:
a fluidic channel configured to flow a sample comprising a plurality of cells, the plurality of cells comprising a plurality of cell types, the plurality of cells stained with a plurality of stains;
an energizer configured to energize the plurality of stained cells to cause the plurality of stained cells to fluoresce light;
a plurality of detectors, each detector configured to measure an intensity of light in a predetermined bandwidth fluoresced by each of the plurality of energized cells;
at least one processor; and
at least one memory comprising instructions that, when executed by the at least one processor, cause the at least one processor to:
generate an observation matrix comprising the intensity measurements by each of the plurality of detectors for each of the plurality of stained cells;
generate a compensation matrix based on the observation matrix, the compensation matrix comprising a compensation coefficient for each of the plurality of detectors;
modify the observation matrix with the compensation matrix to generate a compensated observation matrix; and
classify each of the plurality of cells into a cell type based on the compensated observation matrix.

14. The system of claim 13, further comprising an output configured to output the classifications of the plurality of cells.

15. The system of claim 13, wherein the at least one memory further comprises instructions that, when executed by the at least one processor, cause the at least one processor to generate the compensation matrix, at least in part, by performing two or more iterations of a compensation process, the compensation process comprising:
performing a clustering algorithm on the observation matrix to generate a clustered observation matrix;
generating an updated compensation matrix based on the clustered observation matrix; and
modifying the clustered observation matrix based on the updated compensation matrix.

16. The system of claim 15, wherein the at least one memory further comprises instructions that, when executed by the at least one processor, cause the at least one processor to terminate the compensation process when consecutive iterations of the compensation process generate updated compensation matrices having corresponding compensation coefficients that differ less than a predetermined threshold.

17. The system of claim 15, wherein the clustering algorithm comprises:
performing an inverse hyperbolic sine transformation (arcsinh) to transform data in the observation matrix to log space;
constructing a shared nearest neighbor (SNN) graph using Euclidean distance metric; and
using a Louvain community finding algorithm to cluster cells in the observation matrix into a plurality of cell clusters.

18. The system of claim 17, wherein the at least one memory further comprises instructions that, when executed by the at least one processor, cause the at least one processor to generate an updated compensation matrix, at least in part, by:
for each cell cluster, computing pairwise correlations among a plurality of channels to form a correlation matrix, each channel corresponding to intensity measurements by a corresponding detector in the plurality of detectors;
summing the correlation matrices across all cell clusters to obtain an overall correlation matrix;
determining whether convergence is achieved by summing off-diagonal elements in the overall correlation matrix;
ranking channel pairs from most to least affected by spillover; and
selecting a top ranked channel pair as the first subset of channels.

19. The system of claim 18, wherein ranking channel pairs from most to least affected by spillover comprises rank ordering all off-diagonal elements in the overall correlation matrix in descending order.

20. The system of claim 18, wherein the at least one memory further comprises instructions that, when executed by the at least one processor, cause the at least one processor to generate an updated compensation matrix by, at least in part:
Step 1—performing a regression analysis on the observation matrix to predict a first channel if the first subset of channels based on a second channel in the first subset of channels to obtain a first compensation coefficient candidate;
Step 2—use the first compensation coefficient candidate to correct the first channel based on the second channel for all cells in a cluster;
Step 3—re-computing a correlation between the first and second channels for each cluster after correction to determine whether correlation is reduced;
performing steps 1, 2, and 3 for each cell cluster to find a spillover coefficient from the second channel to the first channel that leads to a reduction of correlation; and
performing steps 1, 2, and 3 for each cell cluster to find a spillover coefficient from the first channel to the second channel that leads to a reduction of correlation.
